(19) United States
(12) Patent Application Publication
(10) Pub. No.: US 2005/0173989 A1
(43) Pub. Date: Aug. 11, 2005

(54) Selectable DC output power converter with voltage level indicating device

(76) Inventor: Michael Wu, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/859,103

(22) Filed: Jun. 3, 2004

(30) Foreign Application Priority Data
Feb. 5, 2004 (TW) 93102691

(51) Int. Cl. H02M 3/18

(52) U.S. Cl. 307/82

(57) ABSTRACT

A power conversion device includes a DC-to-DC conversion circuit that receives and processes a DC power input and supplies a DC output of a predetermined voltage level, an output connector receiving the DC output and having power terminals to transmit the DC output and a plurality of level-selecting terminals, a terminal device having counterpart power terminals and a plurality of counterpart level-selecting terminals, which engage the power terminals and the level-selecting terminals of the output connector, respectively, a feedback circuit coupled to the DC-to-DC conversion circuit and connected to each level-selecting terminal by a resistor having a predetermined resistance to provide a feedback signal to the DC-to-DC conversion circuit which in turn changes the voltage level of the DC output, and a display circuit, which is coupled to the output connector to display the voltage level of the DC output at the power terminals of the output connector.

### BACKGROUND OF THE INVENTION

1. Field of the Invention

The present invention relates generally to a power conversion device, which can be made in the form of an adaptor, and in particular to a power converter comprising an output voltage level indicating device for indication and easy reading of selectable output levels of voltage.

2. Description of the Prior Art

Portable electronic appliances, such as mobile phone and notebook computer, play an important role in the modern world in doing business and society activities. Such portable appliances are often powered by built-in power sources, which must be constantly recharged in order to maintain operability of the portable appliances. Also, external powering is also available for most of the portable appliances, such as wall outlet, automobile electrical system including cigarette lighter socket and electrical socket regularly available in airplanes. Often the external powering must be converted by for example a conversion circuit made in the form of an adaptor before it can be supplied to the portable appliances.

However, the portable appliances are often operated with different working voltages and for such a reason, the general consumers that own and use two or more different portable appliance must regularly bring two or more adaptors corresponding to those portable appliances. This complicates the use of the portable appliances and is very troublesome to the consumers. U.S. Pat. No. 6,628,535, issued to the present inventor, teaches a power conversion device that provides variable output voltage levels to different appliances or loads. The power conversion device of the '535 patent comprises an output to which a terminal connector is selectively coupled. The terminal connector comprises a circuit comprised of resistors that generates a feedback signal to a control circuit of the power conversion device, inducing a corresponding voltage level at the output of the conversion device.

Such a conventional power conversion device works well in supplying voltage of different levels to electronic appliances that operates with different working voltages. It, however, is still unclear to a user what voltage level is being output by the power conversion device when the device is powering an electronic appliance. This may cause problem to the user.

Thus, the present invention is aimed to provide a power conversion device that overcomes the drawback of the conventional devices.

### SUMMARY OF THE INVENTION

An object of the present invention is to provide a power conversion device that selectively supplies output voltage of different levels to different electronic appliances and comprising indicating device that shows or indicates the output voltage level that is being supplied.

Another object of the present invention is to provide a multi-output power conversion device comprising an indicating device that displays or indicates an output level for each output.

To achieve the above objects, in accordance with the present invention, there is provided a power conversion device comprising a DC-to-DC conversion circuit that receives and processes a DC power input and supplies a DC output of a predetermined voltage level, an output connector receiving the DC output and having power terminals to transmit the DC output and a plurality of level-selecting terminals, a terminal device having counterpart power terminals and a plurality of counterpart level-selecting terminals, which engage the power terminals and the level-selecting terminals of the output connector, respectively, a feedback circuit coupled to the DC-to-DC conversion circuit and connected to each level-selecting terminal by a resistor having a predetermined resistance to provide a feedback signal to the DC-to-DC conversion circuit which in turn changes the voltage level of the DC output, and a display circuit, which is coupled to the output connector to display the voltage level of the DC output at the power terminals of the output connector.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a power conversion device constructed in accordance with a preferred embodiment of the present invention with connection cables detached therefrom;

FIG. 2 is a block diagram of a control circuit of the power conversion device of the present invention;

FIG. 3 is a first embodiment of a voltage level indicating circuit in accordance with the present invention;

FIG. 4 is a second embodiment of the voltage level indicating circuit in accordance with the present invention;

FIG. 5 is a third embodiment of the voltage level indicating circuit in accordance with the present invention;

FIG. 6 is a perspective view of a power conversion device constructed in accordance with another preferred embodiment of the present invention with connection cables detached therefrom; and

FIG. 7 is a block diagram of a control circuit of the power conversion device illustrated in FIG. 6.

### DETAILED DESCRIPTION OF THE PREFERRED EMBODIMENTS

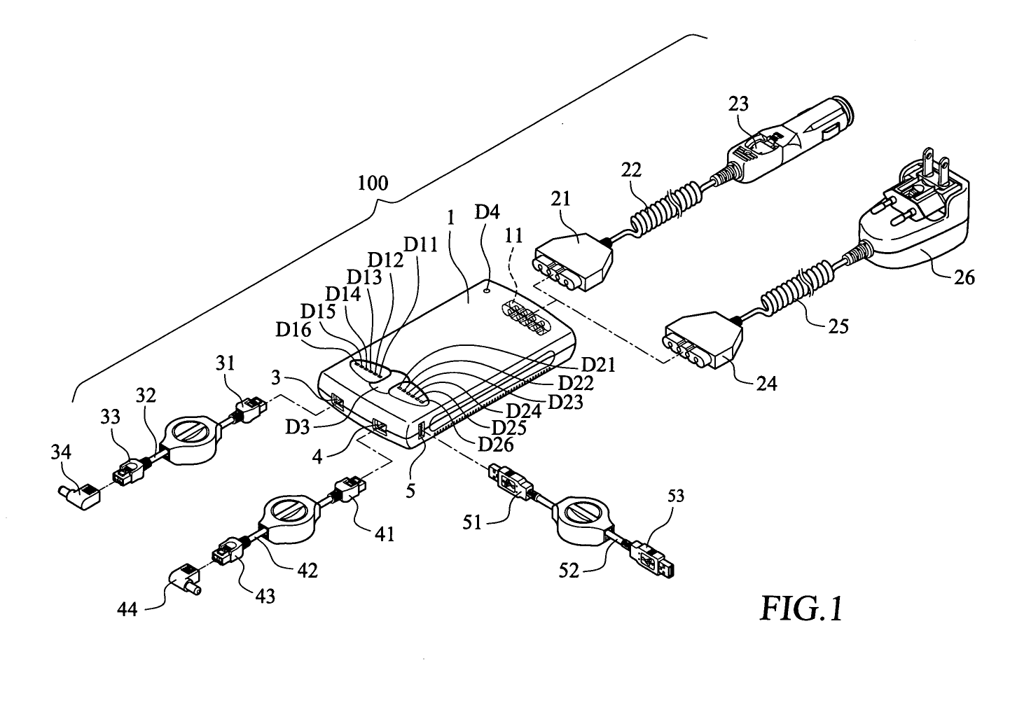

With reference to the drawings and in particular to FIG. 1, a power conversion device constructed in accordance with the present invention, generally designated with reference numeral 100, comprises a casing 1 that forms an input socket 11 with which a plug 21 of a power cord 22 is engageable. The power cord 22 has a proximal end forming the plug 21 and a remote end forming a plug connector 23 that is compatible to and engageable with a standard cigarette lighter socket provided in an automobile (both not shown). Thus, power from an electrical system of an automobile can be supplied by the power cord 22 to the power conversion device 100 of the present invention. The plug connector 23 can be configured to mate with a power socket provided in an airplane.

The power conversion device 100 is provided with an alternative power cord 25 having opposite ends forming a plug 24 that is engageable with the input socket 11 of the casing 1 and a plug 26 for selective engagement with an electrical main, such as a wall outlet (not shown). Preferably, the plug 26 is of a universal design that is compatible with different types of wall outlet around the worlds, such as wall outlets of 110 and 220 volts.

The casing 1 forms first and second output sockets 3, 4, both supplying direct current outputs. Two extension cables 32, 42 are provided to respectively connect an electronic appliance (not shown) to the first and second output sockets 3, 4. The first extension cable 32 has opposite ends forming a device-side plug 31 and an appliance-side connector 33, respectively. The device-side plug 31 is engageable with the first output socket 3 and the appliance-side connector 33 is engageable with a first level-selecting terminal device 34, which provides output voltage of V1+, V1− that is variable (to be further discussed hereinafter) to an electronic appliance powered by the power conversion device 100 via the first extension cable 32. Preferably, the first extension cable 32 is releasably stowed in a cable-winding device (not labeled) to avoid entangling of the cable.

Similarly, the second extension cable 42 has opposite ends forming a device-side plug 41 and an appliance-side connector 43, respectively. The device-side plug 41 is engageable with the second output socket 4 and the appliance-side connector 43 is engageable with a second level-selecting terminal device 44, which provides output voltage of V2+, V2− that is variable (to be further discussed hereinafter) to an electronic appliance powered by the power conversion device 100 via the second extension cable 42. Preferably, the second extension cable 42 is releasably stowed in a cable-winding device (not labeled) to avoid entangling of the cable.

The casing 1 further forms a third output socket 5 for powering an electronic appliance via a third extension cable 52. The third extension cable 52 has opposite ends, respectively forming a device-side plug 51 that is engageable with the third output socket 5 and an appliance-side USB (Universal Serial Bus) plug 53 that supplies a constant direct current output of voltage V3+, V3− of for example 5 volts. Such a constant output can be used to power small-load appliance (not shown). Preferably, the third extension cable 52 is releasably stowed in a cable-winding device (not labeled) to avoid entangling of the cable.

The casing 1 has a top face (not labeled) on which display means is formed to indicate/display the output voltage level of each level-selecting terminal device 34, 44. For example, the display means may comprise a set of first indicators D11-D16 associated with, and preferably adjacent to, the first output socket 3 for indicating/displaying the voltage output V1+, V1−, and set of second indicators D21-D26 associated with, and preferably adjacent to, the second output socket 4 for indicating/displaying the voltage output V2+, V2−. A further indicator D3 is arranged on the top face of the casing 1 for indicating normal/abnormal condition of the output voltage V3+, V3−. A power indicator D4 is also provided on the top face of the casing 1 to indicate normal/abnormal input of power from an external power source through the input socket 11.

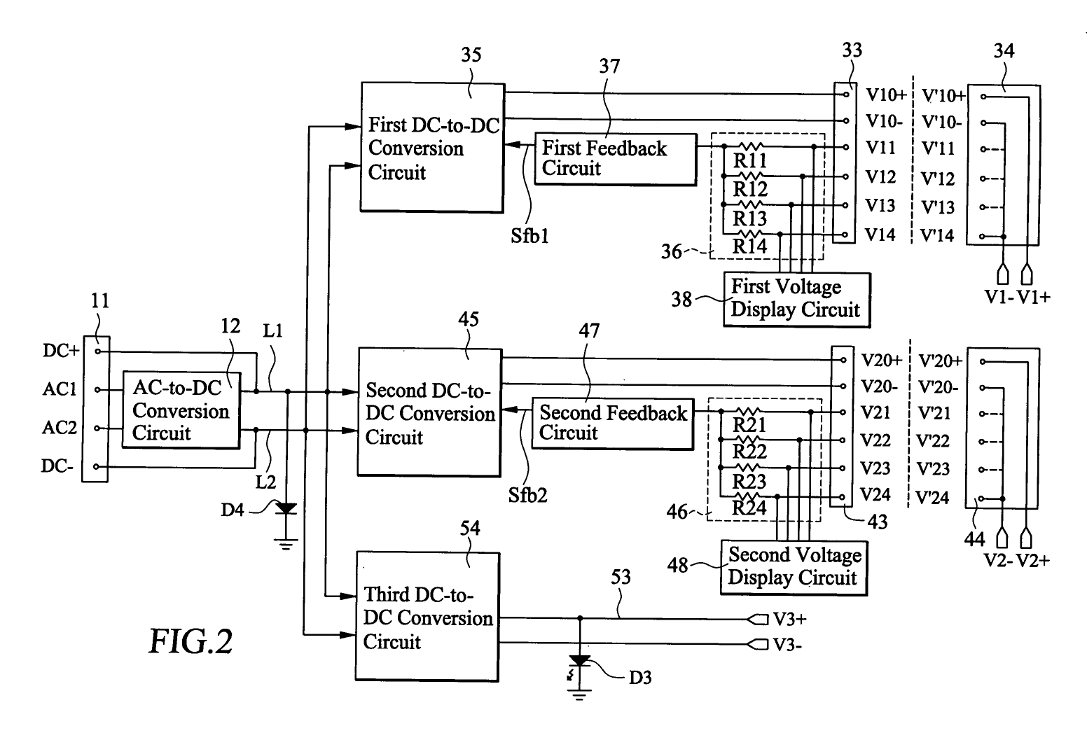

Also referring to FIG. 2, which shows a block diagram of a control circuit of the power conversion device 1, the input socket 11 comprises direct current input terminals DC+, DC− and alternate current input terminals AC1, AC2, which are arranged to respectively receive electrical current from the plug 21 of the power cord 22 (DC input) and the plug 24 of the alternative power cord 25 (AC input) when the plugs 21, 24 are alternately inserted into the input socket 11. The DC input terminals DC+, DC− are directly coupled to lines L1, L2 of the control circuit, while the AC input terminals AC1, AC2 are coupled to the lines L1, L2 via a AC-to-DC conversion circuit 12, which converts the AC input from the power cord 25 into DC power that is then applied to the line L1, L2. Indicator D4 shows normal operation of power receiving through the power cords 22, 25.

The control circuit comprises first, second, and third DC-to-DC conversion circuits 35, 45, 54, respectively associated with the first, second, and third output sockets 3, 4, 5, all connected to the line L1, L2 to receive power from the input socket 11. With the device-side plug 31, 41, 51 of each extension cable 32, 42, 52 received in the associated output socket 3, 4, 5, the first, second, and third DC-to-DC conversion circuits 35, 45, 54 are respectively and electrically connected to the first, second, and third appliance-side connectors 33, 43, 53.

The first appliance-side connector 33 comprises primary, power terminals V10+, V10− coupled to the first DC-to-DC conversion circuit 35. A first resistor network 36 and a first feedback circuit 37, which are connected in series, are connected between the first appliance-side connector 33 and the first DC-to-DC conversion circuit 35 in parallel to the connection between the primary terminals V10+, V10− and the first DC-to-DC conversion circuit 35. The first feedback circuit 37 provides a first feedback signal Sfb1 to the first DC-to-DC conversion circuit 35. The first resistor network 36 is comprised of resistors R11, R12, R13, and R14, which are in turn connected to secondary, level-selecting terminals V11, V12, V13, and V14 of the first appliance-side connector 33. A first voltage display circuit 38 is connected to the secondary, level-selecting terminals V11, V12, V13, and V14 of the first resistor network 36.

The first level-selecting terminal device 34 is comprised of primary and secondary terminals V′10+, V′10−, V′11, V′12, V′13, and V′14, which respectively engage the primary and secondary terminals V10+, V10−, V11, V12, V13, and V14 of the first appliance-side connector 33, when the first level-selecting terminal device 34 mates the first appliance-side connector 33. By selective use of different jump connection between the secondary terminals V′11, V′12, V′13, and V′14 and the primary terminal V′10−, a different resistance is observed in the first resistor network 36, which changes the first feedback signal Sfb1 and thereby changes the output level of voltage at the output V1+, V1− of the first level-selecting terminal device 34. The output level of voltage at output V1+, V1− is displayed on the first voltage display device 38.

Similarly, the second appliance-side connector 43 comprises primary, power terminals V20+, V20− coupled to second DC-to-DC conversion circuit 45. A second resistor network 46 and a second feedback circuit 47, which are connected in series, are connected between the second appliance-side connector 43 and the second DC-to-DC conversion circuit 45 in parallel to the connection between the primary terminals V20+, V20− and the second DC-to-DC conversion circuit 45. The second feedback circuit 47 provides a second feedback signal Sfb2 to the second DC-to-DC conversion circuit 45. The second resistor network 46 is comprised of resistors R21, R22, R23, and R24, which are in turn connected to secondary, level-selecting terminals V21, V22, V23, and V24 of the second appliance-side connector 43. A second voltage display circuit 48 is connected to the secondary, level-selecting terminals V21, V22, V23, and V24 of the second resistor network 46.

The second level-selecting terminal device 44 is comprised of primary and secondary terminals V′20+, V′20−, V′21, V′22, V′23, and V′24, which respectively engage the primary and secondary terminals V20+, V20−, V21, V22, V23, and V24 of the second appliance-side connector 43, when the second level-selecting terminal device 44 mates the second appliance-side connector 43. By selective use of different jump connection between the secondary terminals V′21, V′22, V′23, and V′24 and the primary terminal V′20−, a different resistance is observed in the second resistor network 46, which changes the second feedback signal Sfb2 and thereby changes the output level of voltage at the output V2+, V2− of the second level-selecting terminal device 44. The output level of voltage at output V2+, V2− is displayed on the second voltage display device 48.

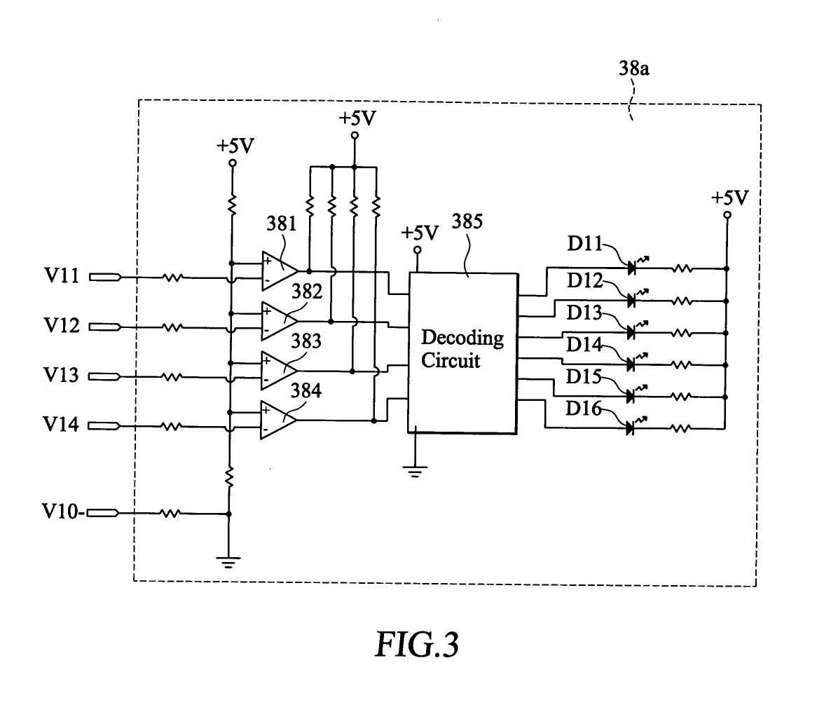

Also referring to FIG. 3, a first example of the first voltage display device 38 comprises a circuit 38a comprising operational amplifiers 381, 382, 383, 384 each having a first input connected to the level-selecting terminals V11, V12, V13, and V14 of the first resistor network 36 whereby each operational amplifier 381, 382, 383, 384 and the associated resistor R11, R12, R13, R14 forms a comparison circuit. Each operational amplifier 381, 382, 383, 384 has a second input connected to a power source of +5V. Each operational amplifier 381, 382, 383, 384 has an output coupled to and applying an output signal to a decoding circuit 385, which in turn generates output signals applied to and driving the indicators D11-D16. Thus, the indicators D11-D16 shows to a user of the power conversion device 100 of the voltage level at the output V1+, V1−.

The circuit 38a may also be applied to the second voltage display device 48 and thus no further description of the detailed structure of the second voltage display device 48 will be given hereinafter.

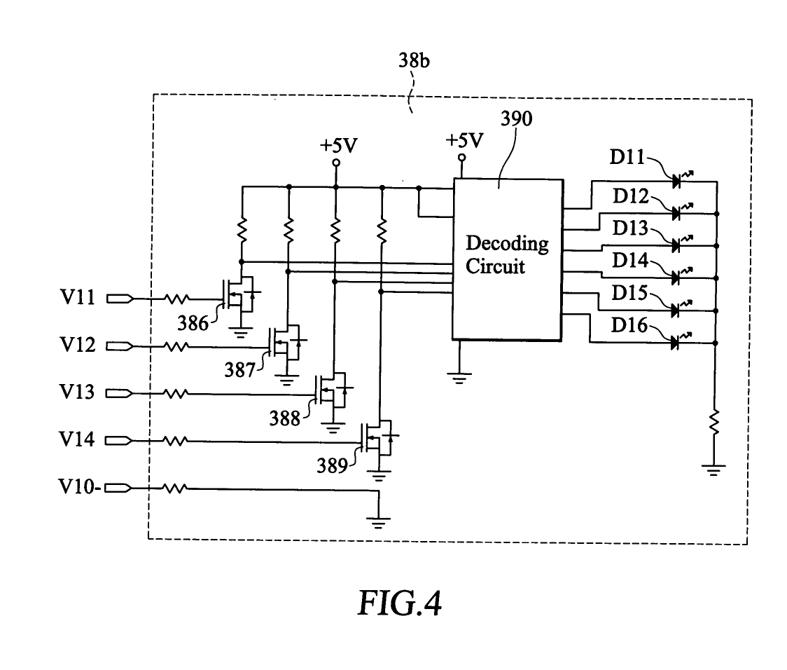

Also referring to FIG. 4, a second example of the first voltage display device 38 comprises a circuit 38b comprising transistors 386, 387, 388, 389 respectively connected to the level-selecting terminals V11, V12, V13, and V14 of the first resistor network 36. Each transistor 386, 387, 388, 389 generates an output signal associated with ON/OFF state thereof and applies the output signal to a decoding circuit 390, which in turn generates output signals applied to and driving the indicators D11-D16. Thus, the indicators D11-D16 shows to a user of the power conversion device 100 of the voltage level at the output V1+, V1−. Again, the second voltage display circuit 48 may incorporate the circuit 38b.

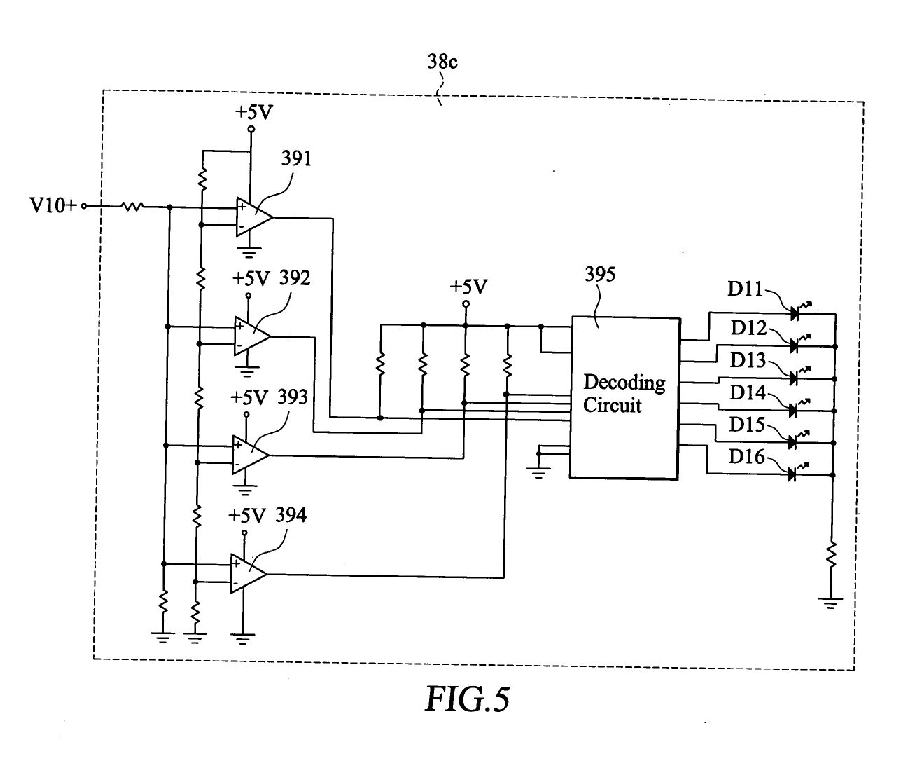

Also referring to FIG. 5, a third example of the first voltage display device 38 comprises a circuit 38c comprising operational amplifiers 391, 392, 393, 394 each having a first input commonly connected to the primary terminal V10+ whereby the operational amplifiers. Each operational amplifier 391, 392, 393, 394 has an output coupled to and applying an output signal to a decoding circuit 395, which in turn generates output signals applied to and driving the indicators D11-D16. Thus, the indicators D11-D16 shows to a user of the power conversion device 100 of the voltage level at the output V1+, V1−. Again, the second voltage display circuit 48 may incorporate the circuit 38c.

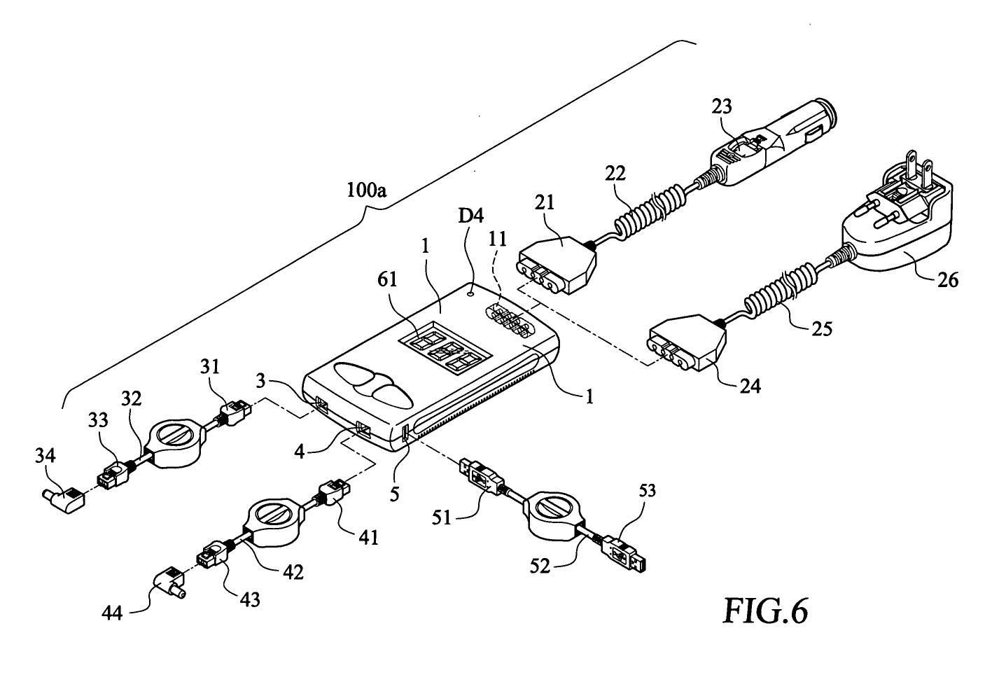

Also referring to FIG. 6, a power conversion device constructed in accordance with another embodiment of the present invention, generally designated with reference numeral 100a, is shown. The power conversion device 100a is substantially identical to the power conversion device 100 with reference to FIGS. 1 and 2, except that the first and second voltage display devices 38, 48 comprise a liquid crystal display device 61. The outputs of the first and second level-selecting terminal device 34, 44 are alternately displayed in the liquid crystal display 61. Alternatively, a manual switch is provided to allow a user to selectively display the outputs of the first and second level-selecting terminal device 34, 44.

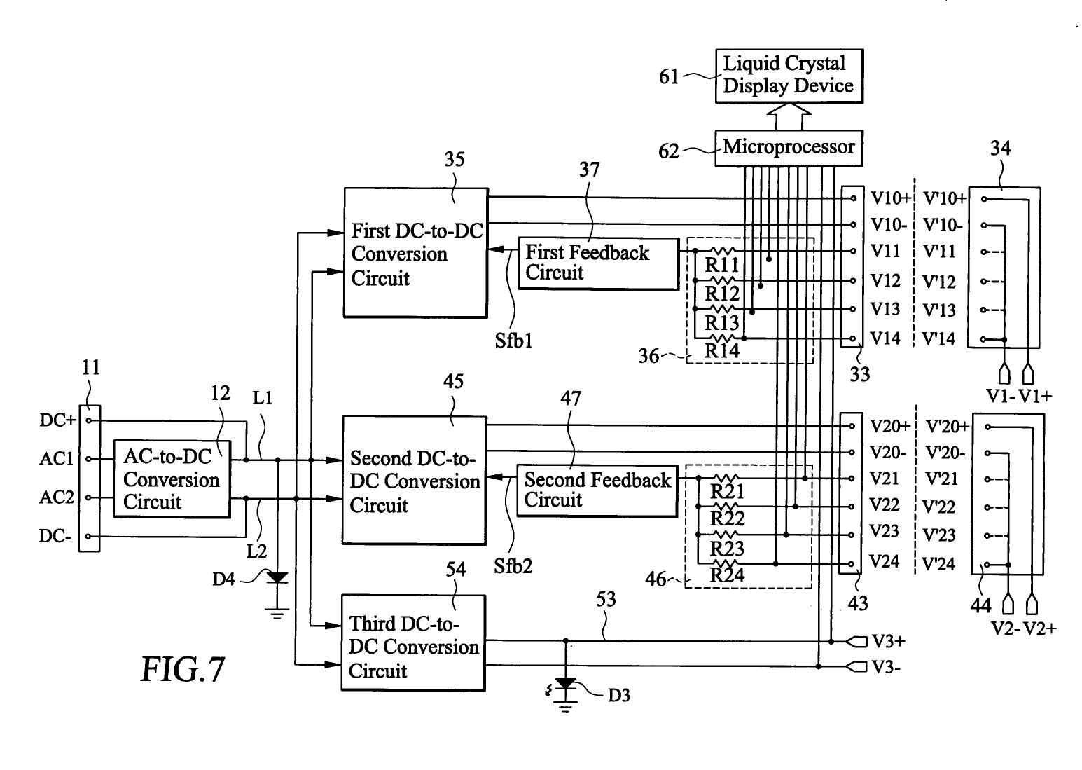

A block diagram of a control circuit of the power conversion device 100a is shown in FIG. 7, which is substantially identical to the control circuit of the power conversion device 100, except that a microprocessor 62 is coupled, via any known interface, to the first and second resistor networks 36, 46, as well as the third DC-to-DC conversion circuit 54 to detect voltage level at the associated outputs. The microprocessor 62 controls the liquid crystal display 61 to display the voltage levels. The first and second voltage display circuits 38, 48 of the power conversion device 100 are thus omitted here.

Although the present invention has been described with reference to the preferred embodiments thereof, it is apparent to those skilled in the art that a variety of modifications and changes may be made without departing from the scope of the present invention intended to be defined by the appended claims.

1. A power conversion device comprising:
a DC-to-DC conversion circuit adapted to receive a DC power input from an external power source and converting the input into a DC output of a predetermined voltage level;
an output connector receiving the DC output and comprising power terminals to transmit the DC output and at least one level-selecting terminal;
a terminal device comprising counterpart power terminals and at least one counterpart level-selecting terminal, the terminal device being selectively mateable with the output connector to have the counterpart power terminals and at least one counterpart level-selecting terminal engaging the power terminals and the at least one level-selecting terminal of the output connector, respectively, and the at least one counterpart level-selecting terminal being selectively connected to the counterpart power terminals;
a feedback circuit coupled to the DC-to-DC conversion circuit and connected to each level-selecting terminal by a resistor having a predetermined resistance, wherein, in response to the connection between the counterpart level-selecting terminal and the counterpart power terminals and based on the predetermined resistance of the resistor, the feedback circuit generates and applies a feedback signal to the DC-to-DC conversion circuit which in turn changes the voltage level of the DC output; and
a display circuit, which is coupled to the output connector to display the voltage level of the DC output at the power terminals of the output connector.

2. The power conversion device as claimed in claim 1, wherein the display circuit comprises indicators connected to the terminals of the output connector to indicate the voltage level of the DC output transmitted through the output connector.

3. The power conversion device as claimed in claim 1, wherein the display circuit comprises a liquid crystal display unit to selectively display the voltage level of the DC output transmitted through the output connector.

4. The power conversion device as claimed in claim 1 further comprising a USB connector that is electrically coupled to an additional DC-to-DC conversion circuit that receives the input power whereby the USB connector is adapted to selectively connect to and supply a constant DC voltage to an external load.

5. A power conversion device comprising:
a plurality of DC-to-DC conversion circuits adapted to receive a DC power input from an external power source and each converting the input into a DC output of a predetermined voltage level;
a plurality of output circuits coupled to the DC-to-DC conversion circuits respectively and each comprising:
an output connector receiving the DC output of the associated DC-to-DC conversion circuit, the output connector comprising power terminals to transmit the DC output and at least one level-selecting terminal,
a terminal device comprising counterpart power terminals and at least one counterpart level-selecting terminal, the terminal device being selectively mateable with the output connector to have the counterpart power terminals and at least one counterpart level-selecting terminal engaging the power terminals and the at least one level-selecting terminal of the output connector, respectively, and the at least one counterpart level-selecting terminal being selectively connected to the counterpart power terminals, and
a feedback circuit coupled to the associated DC-to-DC conversion circuit and connected to each level-selecting terminal by a resistor having a predetermined resistance, wherein, in response to the connection between the counterpart level-selecting terminal and the counterpart power terminals and based on the predetermined resistance of the resistor, the feedback circuit generates and applies a feedback signal to the associated DC-to-DC conversion circuit which in turn changes the voltage level of the DC output thereof; and
display means coupled to each output connector to selectively display the voltage level of the DC output at the power terminals of the output connector.

6. The power conversion device as claimed in claim 5, wherein the display means comprises a display circuit coupled to each output connector, the display circuit comprising indicators connected to the terminals of the output connector to indicate the voltage level of the DC output transmitted through the output connector.

7. The power conversion device as claimed in claim 5, wherein the display means comprises a liquid crystal display unit to selectively display the voltage level of the DC output transmitted through each output connector.

8. The power conversion device as claimed in claim 5 further comprising a USB connector that is electrically coupled to an additional DC-to-DC conversion circuit that receives the input power whereby the USB connector is adapted to selectively connect to and supply a constant DC voltage to an external load.

9. A power conversion device comprising:
a casing forming a power input socket adapted to receive a power plug that is connected to an external power source and at least one power output socket;
an output connector electrically coupled to each power output socket by a plug member of an extension cable;
an output level selecting device mateable with the output connector and comprising a circuit for selectively switching an output voltage between at least two different levels; and
a display unit, which is arranged on the casing to display the level of the output voltage.

10. The power conversion device as claimed in claim 9, wherein the display unit comprises indicators that indicate the level of the output voltage.

11. The power conversion device as claimed in claim 9, wherein the display unit comprises a liquid crystal display to selectively display the level of the output voltage.

12. The power conversion device as claimed in claim 9 further comprising a socket that supplies a constant output voltage and an extension cable having a plug mateable with the socket and a USB connector adapted to supply the constant output voltage to an external load.
